(19) United States
(12) Patent Application Publication
(10) Pub. No.: US 2015/0151665 A1
(43) Pub. Date: Jun. 4, 2015

(54) CARGO STABILIZATION SYSTEM AND METHOD

(71) Applicant: OnLine Transport, Inc., Greenfield, IN (US)

(72) Inventors: Kyle Taylor, Westfield, IN (US); Mark Nutter, Indianapolis, IN (US)

(21) Appl. No.: 14/558,091

(22) Filed: Dec. 2, 2014

Related U.S. Application Data
(60) Provisional application No. 61/910,608, filed on Dec. 2, 2013.

(51) Int. Cl. B60P 7/08

(52) U.S. Cl. CPC B60P 7/0892

(57) ABSTRACT

A cargo stabilization system including a cargo carrier, a cargo unit supported by a floor of the cargo carrier, and at least one cargo stabilization unit. The cargo unit has outer edges which are defined by a pair of adjacent and angularly offset outer side surfaces, with at least one of the edges constituting a free edge. Each cargo stabilization unit is associated with a corresponding one of the free edges of the cargo unit, and each cargo stabilization unit includes first and second inner side surfaces which are offset from one another by an angle corresponding to the angular offset of the outer side surfaces which define an associated outer edge of the cargo unit. Each cargo stabilization unit includes a fastener opening mounting pattern, and is secured to the floor by a number of fasteners passing through fastener openings of the fastener opening mounting pattern.

### CROSS REFERENCE TO RELATED APPLICATIONS

The present application claims the benefit of U.S. Provisional Patent Application No. 61/910,608 filed on Dec. 2, 2013, the contents of which are incorporated herein by reference in their entirety.

### TECHNICAL FIELD

The present application generally relates to cargo stabilization devices, and more particularly but not exclusively to cargo stabilization systems including several of the cargo stabilization devices.

### BACKGROUND

Cargo stabilization devices are sometimes used to prevent cargo from shifting during transport in a cargo carrier. Such devices include, for example, straps, chains, poles and other types of cargo stabilizers. Some such systems have certain limitations, including those relating to cost and customizability. Therefore, a need remains for further improvements in this area of technology.

### SUMMARY

An exemplary system includes a cargo carrier, a cargo unit supported by a floor of the cargo carrier, and at least one cargo stabilization unit. The cargo unit has a plurality of outer edges, each of which is defined by a pair of adjacent and angularly offset outer side surfaces. At least one of the outer edges constitutes a free edge. Each cargo stabilization unit is associated with one of the free edges of the cargo unit, and includes first and second inner side surfaces offset from one another by an angle corresponding to the offset angle of the outer side surfaces which define the associated outer edge of the cargo unit. Each cargo stabilization unit includes a number of fastener openings, and is secured to the floor by a plurality of fasteners passing through the fastener openings. Further embodiments, forms, features, and aspects of the present application shall become apparent from the description and figures provided herewith.

### BRIEF DESCRIPTION OF THE FIGURES

FIG. 1 is a plan view of a cargo stabilization unit according to one embodiment.

FIG. 2 is a side perspective view of the cargo stabilization unit illustrated in FIG. 1.

FIG. 3 is a plan view of a cargo stabilization system according to one form of the invention including a plurality of the cargo stabilization units illustrated in FIG. 1 engaged with a cargo unit on a cargo carrier.

FIG. 4 is a side perspective view of a portion of the cargo stabilization system illustrated in FIG. 3.

FIG. 5 is a schematic flowchart of an exemplary method of making the cargo stabilization unit illustrated in FIG. 1.

FIG. 6 is a schematic flowchart of an exemplary method of using the cargo stabilization unit illustrated in FIG. 1.

FIG. 7 is a plan view of an alternative configuration of the cargo stabilization system illustrated in FIG. 3.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

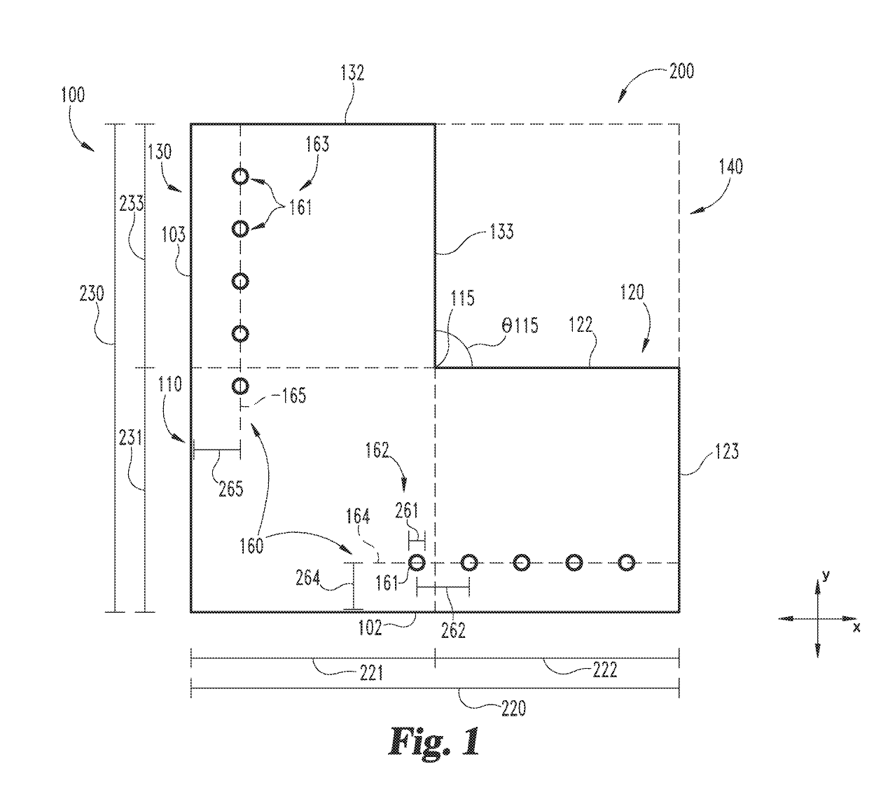

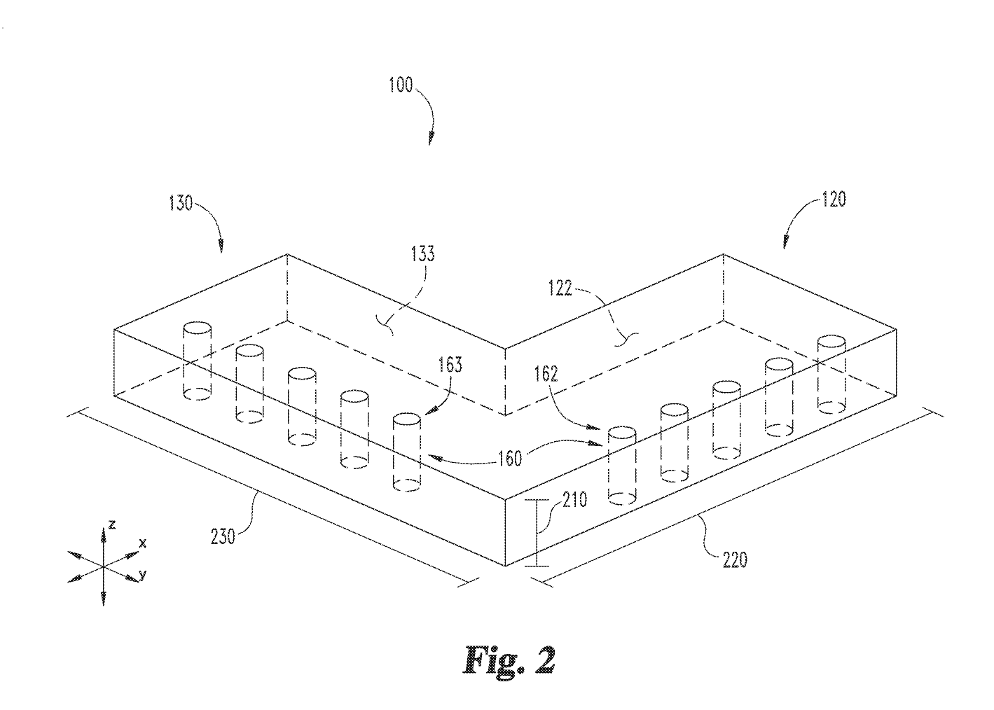

As used herein, the terms “longitudinal”, “lateral”, and “transverse” are used to denote motion or spacing along or substantially along three mutually perpendicular axes. In the coordinate planes illustrated in FIGS. 1 and 2, the X-axis defines the lateral or “left” and “right” directions, the Y-axis defines the longitudinal or “proximal” and “distal” directions, and the Z-axis defines the transverse directions. These terms are used for ease of convenience and description, and are without regard to the orientation of the system with respect to the environment. Additionally, motion or spacing along one direction need not preclude motion or spacing along another of the directions. For example, elements which are described as being “laterally offset” from one another may also be offset in the longitudinal and/or transverse directions, or may be aligned in the longitudinal and/or transverse directions. The terms are therefore not to be construed as limiting the scope of the subject matter described herein.

With reference to FIGS. 1 and 2, a cargo stabilization unit 100 according to one embodiment includes a base portion 110, a first arm 120 extending laterally from the base portion 110, and a second arm 130 extending longitudinally from the base portion 110. As described in further detail below, the unit 100 may be formed by removing a cutout portion 140 from a square work piece. The unit 100 is substantially flat/planar and has a plurality of dimensions 200 including a transverse dimension 210, a lateral dimension 220 and a longitudinal dimension 230. In the illustrated form, the transverse dimension 210 is less than the lateral and longitudinal dimensions 220, 230, with the lateral and longitudinal dimensions 220, 230 being substantially equal to one another in the illustrated embodiment. However, in other embodiments, the lateral and longitudinal dimensions 220, 230 need not be substantially equal to one another. It should be understood that terms such as “substantially” and “about” may be applied to modify a quantitative representation which could permissibly vary without resulting in a change in the basic function to which it relates.

The base portion 110 is defined in part by a laterally-extending proximal side surface 102 and a longitudinally-extending left side surface 103. The proximal side surface 102 also partially defines the first arm 120, and the left side surface 103 also partially defines the second arm 130. The first arm 120 is further defined by a laterally-extending first inner side surface 122 and a longitudinally-extending right side surface 123. The second arm 130 is further defined by a laterally-extending distal side surface 132 and a longitudinally-extending second inner side surface 133. The inner side surfaces 122, 133 are adjacent to and angularly offset from one another, defining an inner edge 115 having an inner edge angle θ115. In the illustrated form, each of the lateral side surfaces 102, 122, 132 is arranged perpendicular to each of the longitudinal side surfaces 103, 123, 133. In other embodiments, one or more of the lateral side surfaces may be arranged substantially perpendicular to one or more of the longitudinal side surfaces, or some of the side surfaces may be offset from one another by an oblique angle.

The lateral dimension 220 of the unit 100 is the sum of a lateral dimension 221 of the base portion 110 and a lateral dimension 222 of the first arm 120. Similarly, the longitudinal dimension 230 of the unit 100 is the sum of a longitudinal dimension 231 of the base portion 110 and a longitudinal dimension 233 of the second arm 130. As noted above, the lateral and longitudinal dimensions 220, 230 are substantially equal to one another such that the unit 100 and the cutout portion 140 generally define a square. Additionally, each of the lateral and longitudinal dimensions 221, 222, 231, 233 are substantially equal to one another such that the base portion 110, the arms 120, 130, and the cutout portion 140 define congruent squares. However, in other embodiments, one or more of the base portion 110, the arms 120, 130 and the cutout portion 140 need not necessarily define a square. For example, one or more of the dimensions may be greater than another of the dimensions, and/or one or more of the side surfaces may be offset from another of the side surfaces by an oblique angle.

The cargo stabilization unit 100 also includes a fastener opening mounting pattern 160 including a plurality of bores or openings 161, each of which is sized and configured to receive a fastener such as a bolt or a screw. The mounting pattern 160 includes a first bore group 162 and a second bore group 163, each of which includes at least one bore 161. In the illustrated form, the first bore group 162 includes a plurality of bores 161 formed in the first arm 120, and the second bore group 163 includes a plurality of bores 161 formed in the second arm 130. Each of the bores 161 has a diameter 261 sized and configured to receive one of the fasteners, and may be offset from an adjacent one of the bores 161 by a bore offset distance 262. The first bore group 162 and/or the second bore group 163 may also include one or more bores 161 formed in the base portion 110. While each of the illustrated bore groups 162, 163 includes a plurality of the bores 161, it is also contemplated that one or both of the bore groups 162, 163 may include a single bore 161.

In the illustrated form, the first bore group 162 includes a series of bores arranged along a first line/axis 164 which is longitudinally offset from the proximal edge 102 by a first line offset distance 264, and the second bore group 163 includes a series of bores arranged along a second line or axis 165 which is laterally offset from the left edge 103 by a second line offset distance 265. As such, the first line/axis 164 is substantially parallel to the lateral axis X, and the second line or axis 165 is substantially parallel to the longitudinal axis Y. In other embodiments, one or both of the lines/axes 164, 165 may be obliquely offset from the respective axes. The mounting pattern 160 may also include additional bores 161. For example, the first group 162 may include an additional line of bores 161 that is longitudinally offset from the illustrated lateral line/axis 164, and/or the second group 163 may include an additional line of bores 161 that is laterally offset from the illustrated longitudinal line/axis 165. In further embodiments, the bores 161 in the mounting pattern 160 need not be arranged along lines and/or need not be uniformly spaced from one another.

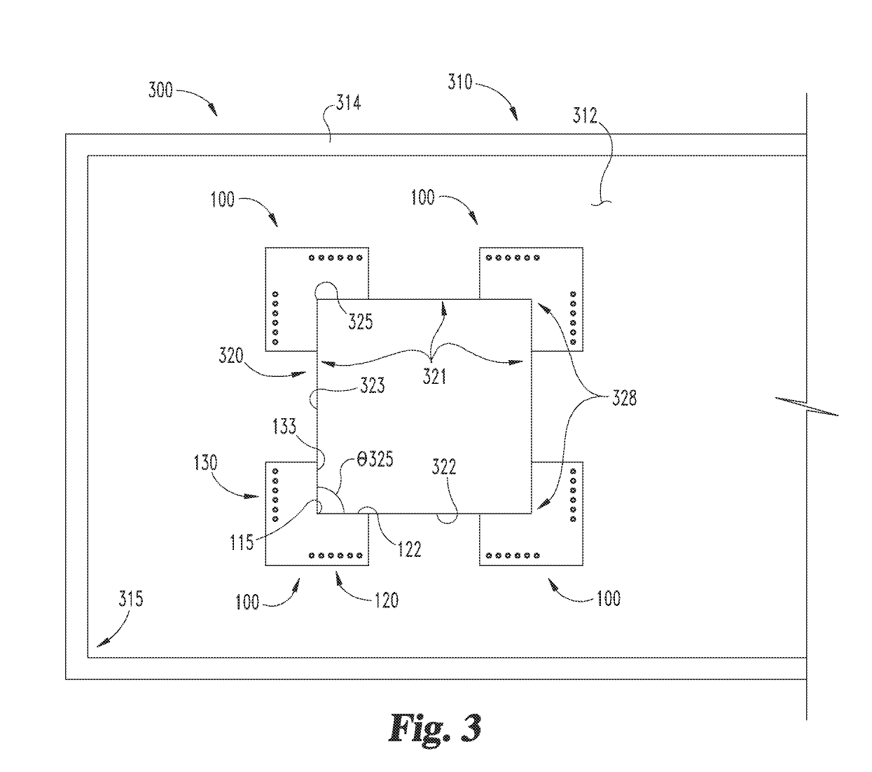

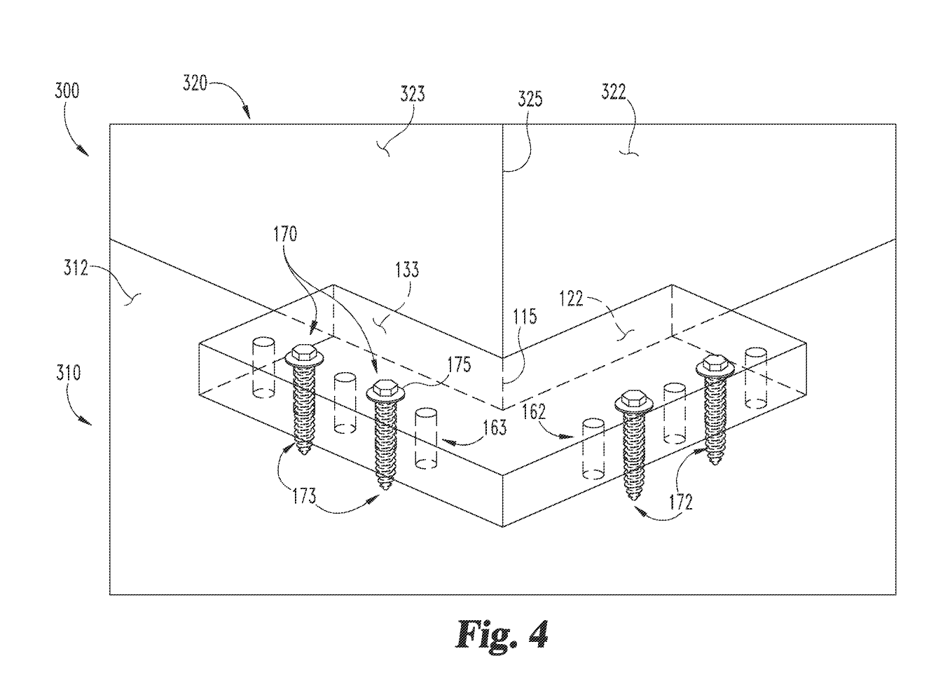

With reference to FIGS. 3 and 4, an exemplary cargo stabilization system 300 includes a plurality of the cargo stabilization units 100, a cargo carrier 310, and a cargo unit 320 which is seated in the cargo carrier 310 and stabilized by the cargo stabilization units 100. The cargo carrier 310 may, for example, constitute a vehicle, a trailer, a freight car, a shipping container, an aircraft, a marine craft, or other types of cargo carriers known to those of skill in the art. In certain embodiments, the cargo unit 320 may constitute a cargo container such as a crate or box. In other embodiments, the cargo unit 320 may constitute a pallet or a palletized stack of cargo. In further embodiments, the cargo unit 320 may constitute various types of cargo.

The cargo carrier 310 includes a floor 312, and may further include one or more walls 314. The cargo unit 320 is supported by the floor 312 of the cargo carrier and includes a plurality of outer side surfaces 321 and a plurality of outer edges 328. Each of the outer edges 328 is defined by two outer side surfaces 321 positioned adjacent to and angularly offset from one another. For example, a first outer side surface 322 is positioned adjacent to and angularly offset from a second outer side surface 323, thereby defining a first outer edge 325 having a first outer edge angle θ325. The outer edge 325 is not positioned adjacent any of the walls 314, and may thus be considered and referred to as a free edge.

A first of the cargo stabilization units 100 is placed on the floor 312 such that the inner edge 115 of the unit 100 is positioned adjacent the first outer edge 325. Additionally, the inner edge angle θ115 corresponds to the outer edge angle θ325, the first inner side surface 122 is positioned adjacent the first outer side surface 322, and the second inner side surface 133 is positioned adjacent the second outer side surface 323. While other forms are contemplated, in the illustrated embodiment, the inner edge angle θ115 is substantially equal to the outer edge angle θ325 such that each of the inner side surfaces 122, 133 abuts and is positioned substantially flush with the corresponding one of the outer side surfaces 322, 323.

As illustrated in FIG. 4, the cargo stabilization unit 100 is secured to the floor 312 by a plurality of fasteners 170. Each of the fasteners 170 extends into the floor 312 via one of the bores 161 in the mounting pattern 160. The fasteners 170 may, for example, constitute screws, bolts, or other suitable threaded fasteners such that the fasteners 170 threadedly engage the floor. The floor 312 may, for example, constitute a wood floor into which threaded portions of the fasteners are screwed. One or more washers 175 may be used in association with each of the fasteners 170 such as, for example, to reduce stress concentrations in the cargo stabilization unit 100. In the illustrated form, a pair of first fasteners 172 extends into the floor 312 via the bores 161 in the first bore group 162, and a pair of second fasteners 173 extends into the floor 312 via the bores in the second bore group 163. In other forms, any number of fasteners 170 may be used in association with the bore groups 162, 163.

As illustrated in FIG. 3 each of the cargo stabilization units 100 is secured to the floor 312 adjacent an associated one of the outer edges 328. The inner edge angle θ115 of each of the cargo stabilization units 100 preferably corresponds to the outer edge angle θ328 of the associated outer edge 328. In each of the cargo stabilization units 100, each of the inner side surfaces 122, 133 is positioned adjacent one of the pair of outer side surfaces 321 which define the associated outer edge 328. In the illustrated form, all of the outer edge angles θ328 are substantially equal to the first outer edge angle θ325, and all of the inner edge angles θ115 are substantially equal to the inner edge angle θ115 of the first cargo stabilization unit 100. In other forms, some of the outer edge angles θ328 may be different from one another and/or the first outer edge angle θ325. In such forms, the inner edge angles θ115 may vary in order to conform to the outer edge angle θ328 of the associated outer edge 328.

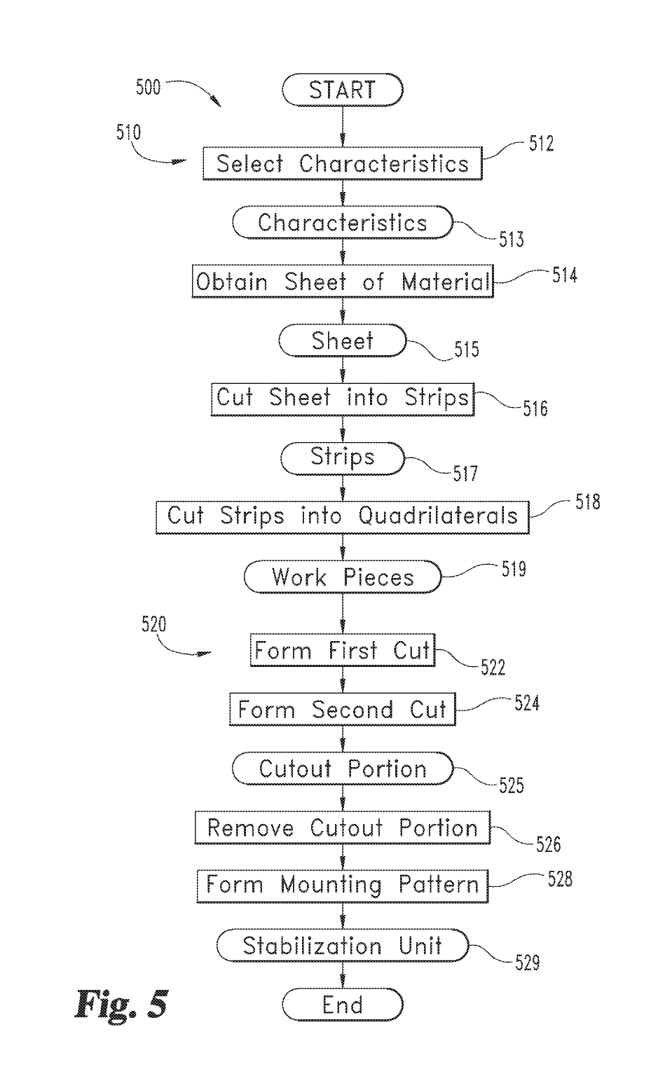

With additional reference to FIG. 5, shown therein is an exemplary process 500 for making the cargo stabilization units such as, for example, the cargo stabilization unit 100. Operations associated with the processes set forth in the present application are understood to be exemplary, and operations may be combined or divided, and added or removed, as well as re-ordered in whole or in part, unless explicitly stated to the contrary. The process 500 generally includes a procedure 510 for forming a plurality of work pieces 519, and a procedure 520 for creating a cargo stabilization unit 529 from one of the pieces 519. While the following description is made with reference to the above-described system 300 and elements and features thereof, it should be appreciated that the process 500 may be utilized to form cargo stabilization units 529 having additional and/or alternative elements and features.

The process 500 may begin with a procedure 510 for creating at least one work piece 519 from which a cargo stabilization unit 100 may be formed. The procedure 510 begins with an operation 512 which includes selecting characteristics 513 for the cargo stabilization unit 100 such as, for example, the material from which the cargo stabilization unit 100 is formed, the dimensions 200 of the cargo stabilization unit 100, and/or the inner edge angle θ115 of the cargo stabilization unit 100. The characteristics 513 may be selected based on characteristics of the cargo unit 320 with which the cargo stabilization unit 100 will be utilized. For example, the dimensions 200 may be selected based on corresponding dimensions and/or the mass of the cargo unit 320, and the inner edge angle θ115 of the cargo stabilization unit 100 may be selected to correspond to the outer edge angle θ325 of the outer edge 328 of the cargo unit 320.

In certain forms, the characteristics 513 may include an inner edge angle θ115 of about ninety degrees, a transverse dimension 210 of about two inches, lateral and longitudinal dimensions 220, 230 of about twelve inches, and base dimensions 221, 231 and arm dimensions 222, 233 of about six inches. In other forms, the characteristics 513 may include an inner edge angle θ115 which is substantially equal to the outer edge angle θ325 of an associated outer edge 328, a transverse dimension 210 between about one inch and about three inches, lateral and longitudinal dimensions 220, 230 between about six inches and about eighteen inches, and base dimensions 221, 231 and/or arm dimensions 222, 233 between about one fourth and about three fourths of the corresponding one of the lateral and longitudinal dimensions 220, 230.

The selected characteristics 513 may also include characteristics associated with the fastener opening mounting pattern 160 such as, for example, the bore diameter 261, the bore offset distances 262, and the number and arrangement of the bores 161 in the bore groups 162, 163. For example, the selected characteristics 513 for the fastener opening mounting pattern 160 may include selecting a bore diameter 261 of about one-half inch, arranging the bore groups 162, 163 along two lines or axes 164, 165 having five bores 161 each, and offset distances 262, 264, 265 of about two inches. Furthermore, the selected characteristics 513 may be nominal characteristics from which the corresponding characteristics of the resulting cargo stabilization unit 100 may permissibly vary slightly, for example due to manufacturing tolerances.

The procedure 510 further includes an operation 514 which includes selecting a sheet 515 of material from which the cargo stabilization unit 100 will be formed. The sheet 515 may be selected based upon the selected characteristics 513 and the number of cargo stabilization units 100 to be formed. For example, the operation 514 may include selecting a sheet 515 of high-density polyethylene (HDP) having a length of about ninety-six inches, a width of about forty-eight inches, and a thickness of about two inches.

The procedure 510 continues to an operation 516 which includes cutting the sheet 515 into a plurality of strips 517. Each of the strips 517 may have a width corresponding to the selected lateral dimension 220. For example, if the selected lateral dimension 220 is about twelve inches, the operation 516 may include cutting the sheet 515 into four strips 517 having a length of about ninety-six inches, or eight strips 515 having a length of about forty-eight inches. The procedure 510 continues to an operation 518 which includes cutting at least one of the strips 517 into a plurality of quadrilaterals, of which at least one is in the form of a work piece 519. For example, the operation 518 may include cutting each of the forty-eight inch strips 517 into four work pieces 519, each of which may be in the general form of a square. Portions or the entirety of the procedure 510 may be iterated to create a plurality of the work pieces 519. In certain embodiments, each of the work pieces 519 may have the same characteristics 513 in each of the iterations. In other embodiments, different characteristics 513 may be selected for some of the iterations.

The process 500 continues to an operation 520 which includes creating a cargo stabilization unit 529 from the work piece 519. The operation 520 begins with an operation 522 which includes forming a first cut in the work piece 519. The longitudinal location and lateral depth of the first cut may, for example, correspond to the longitudinal and lateral dimensions 231, 222, respectively. The operation 520 continues to an operation 524 which includes forming a second cut in the work piece 519, wherein the second cut approaches the first cut at the selected inner edge angle θ115. The lateral location and longitudinal depth of the second cut may, for example, correspond to the lateral and longitudinal dimensions 221, 233, respectively. The second cut may intersect the first cut at the inner edge angle θ115, thereby forming the inner surfaces 122, 133 and the inner edge 115, thereby creating a cutout portion 525.

The procedure 520 continues to an operation 526 which includes removing the cutout portion 525 from the work piece 519. The operation 526 may be included in the operation 524 such as, for example, in embodiments in which the first cut intersects the second cut. In other embodiments, the operation 526 may include breaking the cutout portion 525 from the work piece 519 such as, for example, in embodiments in which the first cut does not intersect the second cut.

The procedure 520 continues to an operation 528 which includes forming a fastener opening mounting pattern in the work piece 519, thereby concluding the creation or fabrication of the cargo stabilization unit 529. For example, the operation 528 may include forming the fastener opening mounting pattern 160 in the work piece 519 to create the cargo stabilization unit 100. The operation 528 may include forming the first line 164 of the bores 161 at the first offset distance 264, and the second line 165 of the bores 161 at the second offset distance 265. Portions or the entirety of the procedure 520 may be iterated to form a plurality of the cargo stabilization units 529 from a plurality of the work pieces 519. The characteristics 513 of the cargo stabilization units 529 may be substantially consistent or may vary from one iteration to the next. Additionally, the procedure 520 may be performed independently of the procedure 510 to create cargo stabilization units 529 from a work piece 519 which was not formed using the procedure 510.

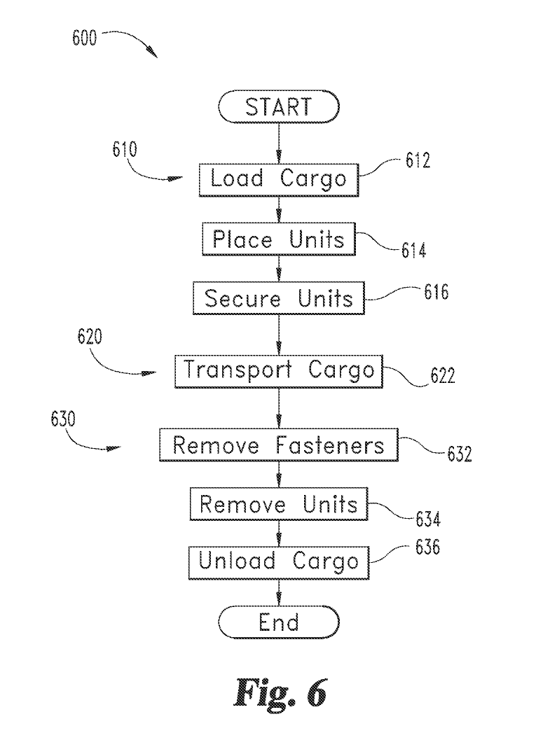

With reference to FIG. 6, shown therein is an exemplary process 600 which may be performed to effectively utilize the cargo stabilization units. Operations illustrated for the processes in the present application are understood to be exemplary only, and operations may be combined or divided, and added or removed, as well as re-ordered in whole or in part, unless explicitly stated to the contrary. In certain forms, the process 600 may be utilized in combination with portions or the entirety of the process 500 to make use of the produced cargo stabilization units 529. In other embodiments, the process 600 may be utilized independently to make use of the cargo stabilization units 100 in the system 300.

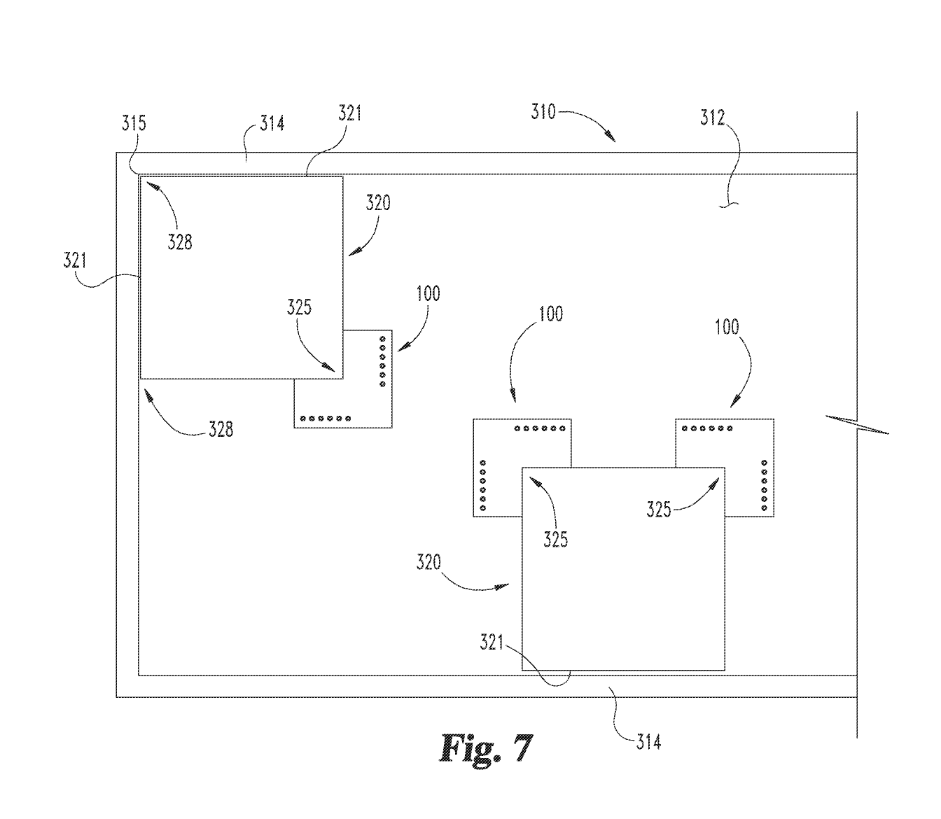

The process 600 generally includes a procedure 610 for loading and securing cargo, a procedure 620 for transporting the cargo, and a procedure 630 for unloading the cargo. The process 600 may begin with a procedure 610 for loading and securing cargo, and more specifically may begin with an operation 612 which includes loading the cargo unit 320 onto the floor 312 of the cargo carrier 310 such that at least one outer edge 328 of the cargo unit 320 is a free edge 325. As used herein, the term “free edge” constitutes an outer edge 328 which is separated or offset from the nearest wall 314 of the cargo carrier 310 by at least a distance sufficient to allow one of the cargo stabilization units 100 to be placed on the floor 312 adjacent to the outer edge 328. For example, in FIG. 3, each of the outer edges 328 is a free edge 325. However, as illustrated in FIG. 7, it is also contemplated that the cargo unit 320 may be loaded on the cargo carrier 310 such that one of the outer side surfaces 321 is positioned adjacent one of the walls 314 which limits shifting of the cargo unit 320 in one direction. In such embodiments, the cargo unit 320 may have two free edges 325 in cases where the cargo unit 320 has a rectangular footprint. In further forms, one of the outer edges 328 of the cargo unit 320 may be positioned adjacent one of the inner edges 315 of the cargo carrier 310 such that the adjacent walls 314 limit shifting of the cargo unit 320 in two directions via positioning of the outer side surfaces 321 of the cargo unit 320 adjacent corresponding walls 314 of the cargo carrier 310. In such embodiments, the cargo unit 320 may have a single free edge 325 in cases where the cargo unit 320 has a rectangular footprint. Regardless of the exact location, the operation 612 includes loading the cargo unit 320 onto the cargo carrier 310 such that at least one of its outer edges 328 constitutes a free edge 325.

With the cargo unit 320 loaded on the cargo carrier 310, the procedure 610 may continue to an operation 614 which includes placing a cargo stabilization unit 100 on the floor 312 of the cargo carrier 310 such that the inner edge 115 of the unit 100 is positioned directly adjacent one of the free edges 325 of the cargo unit 320. As a result of the operation 614, each of the inner side surfaces 122, 133 of the cargo stabilization unit 100 is positioned directly adjacent one of the outer side surfaces 322, 323 defining a free edge 325 of the cargo unit 320. In certain forms, one or more of the inner side surfaces 122, 133 may abut the corresponding one of the outer side surfaces 322, 323 such as, for example, in embodiments in which it is desired to substantially prevent shifting of the cargo unit 320 during transportation.

With the cargo stabilization unit 100 in place, the procedure 610 may continue to an operation 616 which includes securing the cargo stabilization unit 100 to the floor 312 of the carrier 310. For example, the operation 616 may include engaging the cargo stabilization unit 100 to the floor 312 via a number of fasteners 170 passing through the mounting pattern 160. In the illustrated embodiment, the operation 616 includes passing a pair of first fasteners 172 through the first bore group 162 and a pair of second fasteners 173 through the second bore group 163. In embodiments in which the fasteners 170 are threaded fasteners (such as screws or bolts), the operation 616 may include screwing the fasteners 170 into the floor 312 which may, for example, be formed of wood. The operations 614, 616 may be repeated, for example, in embodiments in which the cargo unit 320 includes more than one free edge 325. Additionally, the operation 612 may be repeated to load additional cargo units 320 onto the cargo carrier 310, and the operations 614, 616 may be repeated to limit shifting of the additional cargo units 320.

Once the cargo stabilization units 100 have been secured to the floor 312 to limit shifting of the one or more cargo units 320, the process 600 continues to the transporting procedure 620 which includes the operation 622 of transporting the cargo units 320. The procedure 620 may further include operating the cargo carrier 310 such as, for example, in embodiments in which the cargo carrier 310 is a vehicle including a prime mover such as an engine. In other embodiments, the procedure 620 may include operating a second vehicle to which the cargo carrier 310 is attached such as, for example, in embodiments in which the cargo carrier 310 constitutes a trailer and/or does not include a prime mover.

When the cargo carrier 310 has reached an unloading point or location, such as a final destination or an intermediate transfer point, the process 600 continues to the unloading procedure 630. The unloading procedure 630 may begin with an operation 632 which includes removing the fasteners 170 from each of the cargo stabilization units 100. The procedure 630 continues to an operation 634 which includes removing the cargo stabilization units 100 from the floor 312 of the cargo carrier 310. The procedure 630 continues to an operation 636 which includes removing or unloading the cargo units 320 from the cargo carrier 310. The procedure 630 may also include placing the cargo stabilization units 100 and the fasteners 170 in a storage location to ensure that the parts do not become lost and/or damaged. For example, the procedure 630 may include performing the operation 636 only after confirmation that all loose cargo stabilization units 100 and fasteners 170 have been placed in a secure storage location. Portions or the entirety of the process 600 may then be repeated to load, secure, transport, and/or unload additional cargo units 320.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow.

In reading the claims appended hereto, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A cargo stabilization system for stabilizing a cargo unit on a floor of a cargo carrier, comprising:
a cargo unit positioned on the floor of the cargo carrier, the cargo unit including a plurality of outer side surfaces and a plurality of outer edges including at least one free edge, wherein each of the outer edges is defined by two of the outer side surfaces positioned adjacent to and angularly offset from one another to define an outer edge angle;
at least one cargo stabilization unit positioned on the floor of the cargo carrier adjacent the cargo unit, wherein each of the at least one cargo stabilization units comprises:
a first leg including a first inner side surface;
a second leg including a second inner side surface angularly offset from the first inner side surface to define an inner edge angle;
a base portion connecting the first leg and the second leg; and
a mounting pattern including a plurality of fastener openings extending through the cargo stabilization unit, wherein a first of the fastener openings extends through the first leg and a second of the fastener openings extends through the second leg; and
a plurality of fasteners coupling each of the at least one cargo stabilization units to the floor of the cargo carrier;
wherein each of the at least one cargo stabilization units is associated with a corresponding one of the free edges and is positioned adjacent the corresponding free edge;
wherein, for each of the at least one cargo stabilization units, the inner edge angle corresponds to the outer edge angle of the corresponding free edge, and each of the inner side surfaces is positioned adjacent a corresponding one of the two outer side surfaces defining the corresponding free edge, and wherein one of the fasteners extends into the floor of the cargo carrier through the first of the fastener openings, and another of the fasteners extends into the floor of the cargo carrier and through the second of the fastener openings.

2. The cargo stabilization system of claim 1, wherein the at least one cargo stabilization unit comprises a plurality of the cargo stabilization units, wherein the plurality of outer edges of the cargo unit includes a plurality of the free edges, and wherein each of the plurality of free edges is associated with a corresponding one of the plurality of cargo stabilization units.

3. The cargo stabilization system of claim 2, wherein the inner edge angle of each of the cargo stabilization units is substantially equal to the outer edge angle of a corresponding free edge.

4. The cargo stabilization system of claim 3, wherein each of the inner edge angles and each of the outer edge angles is substantially equal to ninety degrees.

5. The cargo stabilization system of claim 2, wherein, in each of the plurality of cargo stabilization units, the mounting pattern comprises a first plurality of the fastener openings formed in the first leg and a second plurality of the fastener openings formed in the second leg.

6. The cargo stabilization system of claim 5, wherein the first plurality of the fastener openings are arranged along a first axis, and the second plurality of the fastener openings are arranged along a second axis transverse to the first axis.

7. The cargo stabilization system of claim 6, wherein the first axis is substantially parallel to the first inner side surface and the second axis is substantially parallel to the second inner side surface.

8. The cargo stabilization system of claim 1, wherein each of the plurality of fasteners includes external threads engaged within an internally threaded opening in the floor of the cargo carrier.

9. The cargo stabilization system of claim 1, wherein the floor of the cargo carrier comprises wood, and the external threads of each of the fasteners are threadedly engaged with the wood.

10. The cargo stabilization system of claim 9, wherein the cargo carrier comprises a trailer.

11. The cargo stabilization system of claim 1, wherein each of the cargo stabilization units is formed of high density polyethylene.

12. The cargo stabilization system of claim 1, wherein, in each of the cargo stabilization units, the first leg extends from the base portion in a lateral direction, and the second leg extends from the base portion in a longitudinal direction transverse to the lateral direction.

13. The cargo stabilization system of claim 1, wherein, in each of the plurality of cargo stabilization units, the first leg, the second leg, and the base portion define congruent squares.

14. A method of stabilizing a cargo unit on a floor of a cargo carrier, the cargo unit including a first outer side surface and a second outer side surface, wherein the first and second outer side surfaces define an outer edge angle, the method comprising:
providing a cargo stabilization unit comprising:
a first leg including a first inner side surface;
a second leg including a second inner side surface angularly offset from the first inner side surface to define an inner edge angle corresponding to the outer edge angle;
a base portion connecting the first leg and the second leg; and
a mounting pattern including a plurality of fastener openings extending through the cargo stabilization unit, wherein at least one of the fastener openings extends through the first leg and at least one of the fastener openings extends through the second leg;
positioning the cargo stabilization unit on the floor of the cargo carrier;
positioning the first inner side surface of the cargo stabilization unit adjacent the first outer side surface of the cargo unit;
positioning the second inner side surface of the cargo stabilization unit adjacent the second outer side surface of the cargo unit; and
securing the cargo stabilization unit to the floor, the securing comprising:
engaging the floor with a plurality of fasteners extending through the fastener openings in the first and second legs.

15. The method of claim 14, wherein the plurality of fasteners comprise threaded fasteners, and wherein the securing comprises threadedly engaging the floor with the threaded fasteners to thereby releasably secure the cargo stabilization unit to the floor and stabilize the cargo unit on the floor of the cargo carrier.

16. A method, comprising:
providing a work piece having a first longitudinal dimension, a first lateral dimension, and a substantially constant transverse dimension;
creating from the work piece a cargo stabilization unit having a first leg, a second leg, and an inner edge, the creating step comprising:
forming a first cut in the work piece;
forming a second cut in the work piece approaching the first cut at a predetermined angle to thereby create a cutout portion;
removing the cutout portion from the work piece, thereby exposing the inner edge; and
forming a fastener opening mounting pattern in the work piece including forming a plurality of fastener openings extending through the cargo stabilization unit in a direction of the transverse dimension, wherein the plurality of fastener openings includes a first fastener opening formed in the first leg and a second fastener opening formed in the second leg; and
utilizing the cargo stabilization unit to discourage shifting of a cargo unit supported by a floor of a cargo carrier, the utilizing comprising:
placing the cargo stabilization unit on the floor such that the inner edge is positioned adjacent an outer edge of the cargo unit; and
securing the cargo stabilization unit to the floor of the cargo carrier with a plurality of fasteners, wherein a first of the fasteners extends through the first fastener opening and a second of the fasteners extends through the second fastener opening.

17. The method of claim 16, wherein the predetermined angle is substantially equal to an angle defined by the outer edge of the cargo unit.

18. The method of claim 16, further comprising:
creating a plurality of the work pieces from a sheet of material, the sheet having a second longitudinal dimension, a second lateral dimension, and the substantially constant transverse dimension, the creating of the plurality of work pieces comprising:
cutting the sheet of material into a plurality of strips having the second longitudinal dimension and the first lateral dimension; and
cutting each of the plurality of strips into a plurality of quadrilaterals having the first longitudinal dimension and the first lateral dimension, wherein each of the quadrilaterals comprises one of the work pieces.

19. The method of claim 18, wherein the cargo unit has a plurality of other outer edges, the method further comprising:
creating another cargo stabilization units for each of the other outer edges, wherein the predetermined angle of each of the another cargo stabilization units corresponds to an angle of a corresponding one of the other outer edges; and
securing each of the another cargo stabilization units to the floor of the cargo carrier adjacent the corresponding one of the other outer edges.

20. The method of claim 16, wherein the floor of the cargo carrier comprises a wood floor, the fasteners are threaded fasteners, and the securing includes threading the threaded fasteners into the wood floor through the first and second fastener openings.
